(19) United States
(12) Patent Application Publication
(10) Pub. No.: US 2008/0291267 A1
(43) Pub. Date: Nov. 27, 2008

(54) Lenticular Autostereoscopic Display Device and Method, and Associated Autostereoscopic Image Synthesising Method

(76) Inventors: Xavier Leveco, Gif Sur Yvette (FR); Armand Azoulay, Paris (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/665,679

(22) PCT Filed: Oct. 14, 2005
(86) PCT No.: PCT/FR05/02562

§ 371 Date: Oct. 1, 2007

(30) Foreign Application Priority Data
Oct. 18, 2004 (FR) 0411018

(51) Int. Cl. H04N 13/04

(52) U.S. Cl. 348/51

(57) ABSTRACT

An autostereoscopic display device includes a matrix display screen and a lenticular array arranged in front of the display screen. The lenticular array is adapted to receive and optically process a raster image transmitted by the display screen, with the raster image being encoded in order to integrate a plurality P of viewpoints of a same scene. The display screen includes a matrix of screen pixels, each of which includes three color cells organized in rows and columns laid out so as to form columns of a same color within the screen. The image transmitted by the display screen comprises a set of three-dimensional pixels, each integrating the plurality P of viewpoints of an image pixel of the scene, and each three-dimensional pixel occupying 3×P color cells in two adjacent rows within the screen.

### RELATED APPLICATIONS

This application claims priority to PCT Application No. PCT/FR2005/0002562 filed Oct. 14, 2005, and French Application No. 0411018 filed Oct. 18, 2004, the disclosures of which are hereby incorporated by reference in their entireties.

### TECHNICAL FIELD

This invention relates to a lenticular autostereoscopic display device. It also concerns an autostereoscopic display method implemented in this device, as well as an associated autostereoscopic image synthesizing method. The field of the invention is more particularly that of three-dimensional color computer and television screens intended, for example, for broadcasting advertising or public information messages or for displaying educational or entertainment content.

### BACKGROUND ART

Glasses-free autostereoscopic display devices are already known, which implement either parallax barrier technologies or lenticular technologies. Overall, an autostereoscopic display screen includes:

a plasma or liquid crystal (LCD) technology, two-dimensional electronic screen broadcasting a previously encoded content, and

a 2 D-3 D conversion screen, arranged at a short distance from the two-dimensional screen and operating during transmission, this screen being capable of being either the parallax barrier type or the lenticular type.

Parallax barriers are easy to implement, and inexpensive to produce, but constitute an impediment, having too much photon loss, especially when it is desired to encode numerous angles of view. Thus, it is possible for less than 10% of an autostereoscopic screen mask to be transmitted. This results in problems relating to the photon flux and brightness of the screen.

Autostereoscopic screens that implement lenticular arrays have very few photon losses and therefore have a transmission rate close to 100%, but are more costly to manufacture and more difficult to use.

Current lenticular color autostereoscopic screens have a horizontal resolution loss problem based on the number of viewpoints. The resolution is overall divided by the number of angles of view.

Thus, a problem posed is to find an appropriate way to encode the P views on the 2 D electronic screen in order to equalize the horizontal and vertical resolution losses, while at the same time preserving the RGB (Red Green Blue) color-encoding. The stereoscopic effect must necessarily be a horizontal effect, due to the morphology of the eyes. Thus, stereoscopic encoding must necessarily be horizontal.

Patent document WO 0010332 discloses encoding horizontally in a row. The encoding of the color is also carried out horizontally in a row, with a different color per successive 3 D pixel (lenticule). Thus, the lenticules are vertical, but the loss of resolution is only along the horizontal axis. The consequence of this is that the image for each take is very dissymmetrical. For example, if a 2 D, 1200×768 pixel size screen is considered, and if 8 images are encoded, the resolution for each view is therefore 150×768, which represents a significant loss of resolution over the entire image.

Furthermore, the colors encoding a 3 D pixel are very distant from each other, with twice the pitch of the lenticule for encoding the three colors. A mixing together of the colors is then obtained, which is not very good on the retina, if many angles of view are desired.

In the autostereoscopic screen disclosed in patent document EP 0791847B1, the views are encoded horizontally overall, but also vertically in a minimum of 3 rows of screen pixels. The color-encoding surface is at least equal to one times the size of the lenticule (in the horizontal direction) per 3 screen pixels (in the vertical direction). The loss of resolution is horizontally and vertically uniform. However, if encoding such as this appears to be appropriate for 2 D screens in which the spacing between the pixels and between the color cells of the pixels is significant, as in the case of some LCD screens, then, by contrast, it cannot be satisfactorily suitable for plasma screens in which the cells are very close together, or even nearly joined together, which would lead to a significant mixing together of the images of the various views.

### SUMMARY OF THE INVENTION

One aspect of the invention is directed to a lenticular color autostereoscopic display device that obtains better resolution than the current devices and that is particularly suited to autostereoscopic equipment having a small number of viewpoints, typically fewer than 8.

In one embodiment, an autostereoscopic display device includes a matrix display screen and a lenticular array arranged in front of the display screen and having a lenticular axis that is inclined in relation to a vertical axis of said display screen, this lenticular array being designed to optically receive and process a raster image transmitted by said display screen, said raster image being encoded in order to integrate a plurality P of viewpoints of the same scene, said display screen including a matrix of screen pixels each including three color cells, said color cells being organized in rows and columns laid out so as to form columns of the same color (e.g., R, G, B) within said screen.

According to one embodiment, the image transmitted by the display screen comprises a set of three-dimensional pixels P3D each integrating the plurality P of viewpoints of an image pixel of said scene, each three-dimensional pixel P3D occupying 3×P color cells in two adjacent rows within said screen.

In this case, an image is understood to mean a scene that is represented in relief. To accomplish this, a plurality P of viewpoints of this image is necessary. One image pixel corresponds to the P viewpoints of one pixel of the scene.

With a display device according to one embodiment, it becomes possible to equalize the loss of resolution in the two horizontal and vertical dimensions of the screen. Thus, for 4 viewpoints, the loss of resolution, with a factor of 2, is the same horizontally and vertically. For higher numbers of viewpoints (e.g., 5 or 7), a ratio of the loss of horizontal resolution to the loss of vertical resolution is attained which is equal to 1.25 (5 viewpoints) and to 1.75 (7 viewpoints), which is on an altogether different scale from the loss of resolution ratios observed in the autostereoscopic devices of the prior art.

Contrary to the encoding techniques used in the devices of the prior art, in one aspect of this invention, a partial separation is made between, on the one hand, the problem of stereoscopy, which must necessarily be dealt with in the horizontal dimension, and that of color- encoding, which is dealt with here in two rows along an encoding axis that is actually that of the lenticular array.

Each three-dimensional pixel P3D of the display device according to—one embodiment can use 2×P adjacent color cells, in one of the two adjacent rows, and, in the other row, P adjacent color cells.

The three-dimensional pixels are laid out whereby two horizontal adjacent three-dimensional pixels are overlapping.

The lenticular array—comprises parallel cylindrical lenses with a lenticular pitch and an angle such that each three-dimensional pixel is substantially covered by two adjacent elementary lenticules.

The tilt angle α is chosen in one embodiment such that tan α is substantially equal to the ratio of the width CCh of a color cell to the height CCv of said color cell.

In one particular embodiment of the invention, each viewpoint with each three-dimensional pixel is encoded:

in a first cell of a first color, situated in a first row,

in a second cell of a second color, situated in said first row and offset by a number P of cells in relation to said first cell, and

in a third cell of a third color, situated in a second row adjacent to said first row, said third cell being horizontally offset by one cell in relation to said first cell.

The number P of viewpoints for an autostereoscopic display device according to embodiments of the invention can be chosen from among 2, 4, 5 or 7.

The autostereoscopic display device according to one aspect of the invention can advantageously include a plasma screen, but also an LCD technology or any other matrix technology screen.

According to another aspect of the invention, an autostereoscopic display method is proposed, which uses an autostereoscopic display device according to one aspect of the invention, including:

displaying an image previously encoded from an image acquired or collected from a plurality P of viewpoints, via a two-dimensional display screen, and

receiving and optically processing said displayed image, via a lenticular array arranged in front of said display screen and having a lenticular axis that is inclined in relation to a vertical axis of said display screen, so as to remotely generate a three-dimensional image, said raster image being encoded in order to integrate a plurality P of viewpoints of said image, characterized in that the optical processing carried out by the lenticular array is designed to process an encoded image comprising a set of three-dimensional pixels P3D each integrating the plurality P of viewpoints of an image pixel of said scene, each three-dimensional pixel P3D occupying 3×P color cells in two adjacent rows within said screen.

According to another aspect of the invention, a method is proposed for synthesizing a color autostereoscopic image, implemented in order to supply a display device—with image content, including, from a plurality P of previously acquired or calculated digital images each in the form of a matrix of image pixels representing a scene, synthesis of an encoded display matrix—comprising an assemblage of three-dimensional pixels each integrating the plurality P of viewpoints of an image pixel of said scene, each three-dimensional pixel occupying 3×P color cells in two adjacent rows within said screen.

### BRIEF DESCRIPTION OF THE DRAWINGS

Other advantages and characteristics of the invention will become apparent upon examination of the detailed description of a non-limiting embodiment, and from the appended drawings in which:

FIG. 1 is a synoptic view of an autostereoscopic display device according to one aspect of the invention.

FIGS. 2A, 2B, 2C and 2D illustrate the internal structure an encoded image processed by the autostereoscopic display device according to one aspect of the invention, for numbers of viewpoints equal to 2, 4, 5 and 7, respectively.

FIG. 3 illustrates the steps of the image synthesizing method according to aspects of the invention.

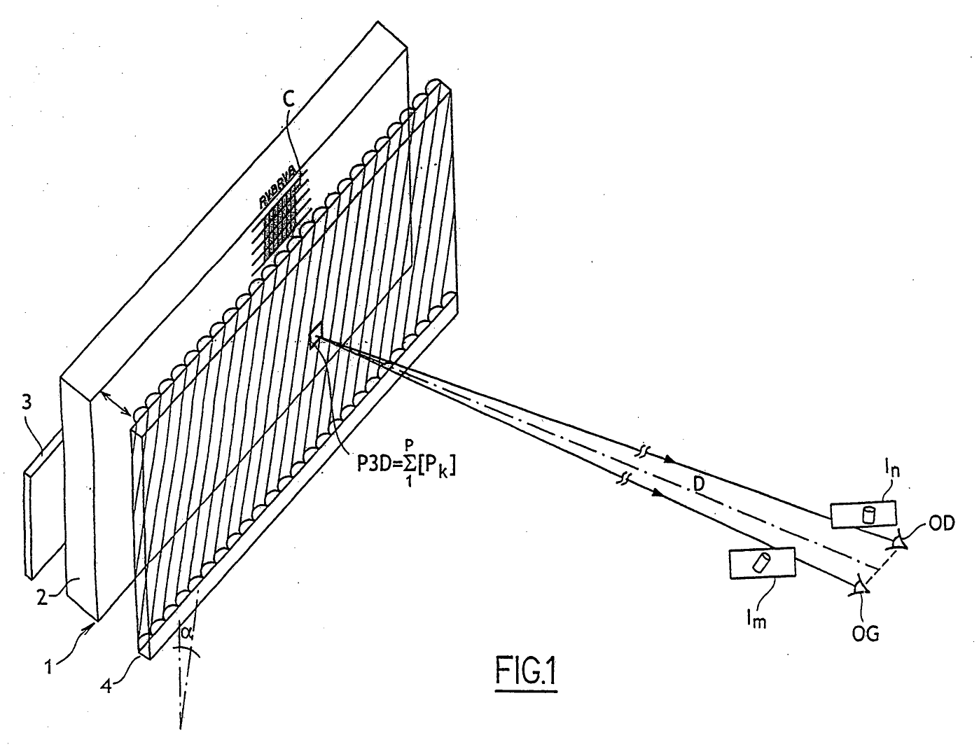

### DETAILED DESCRIPTION

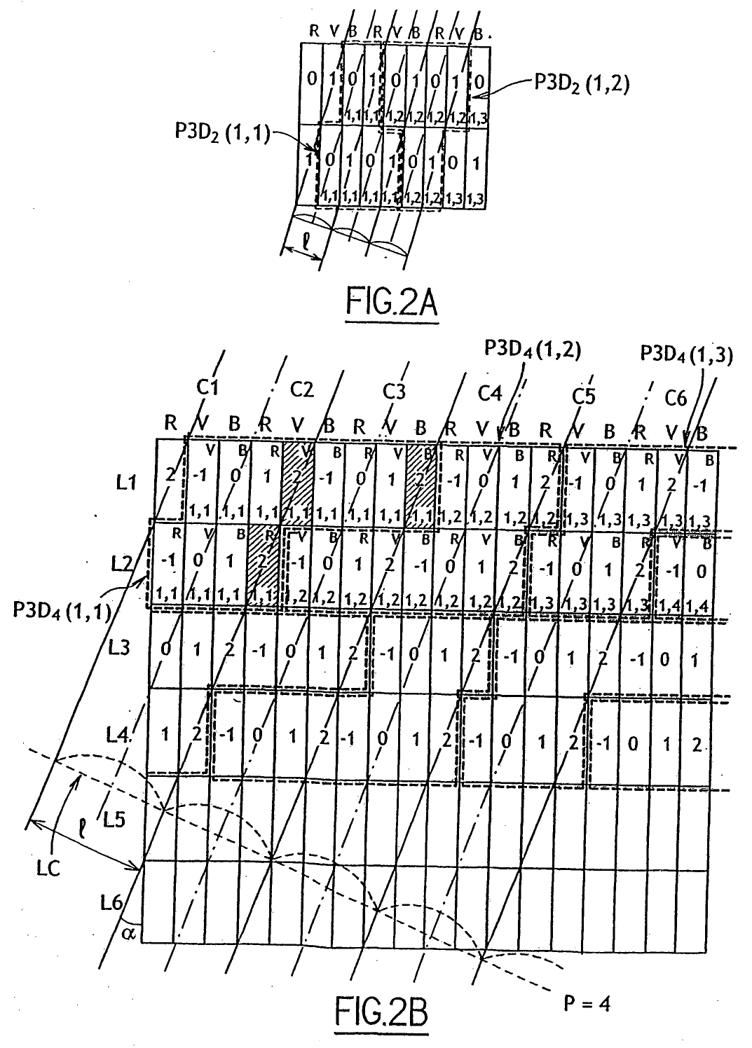

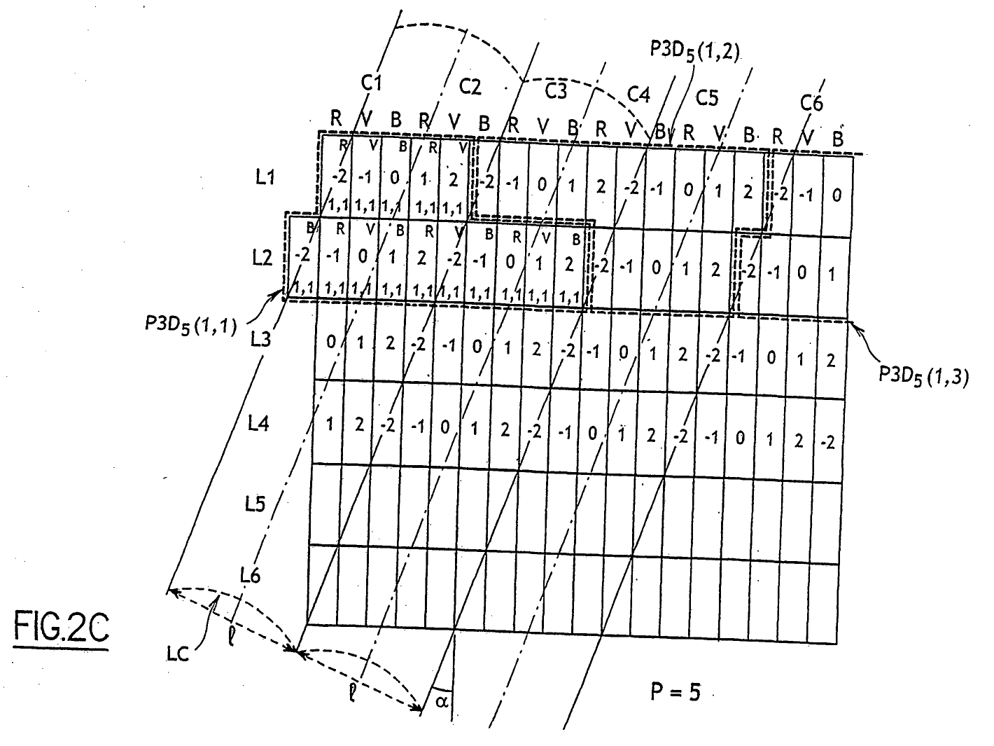

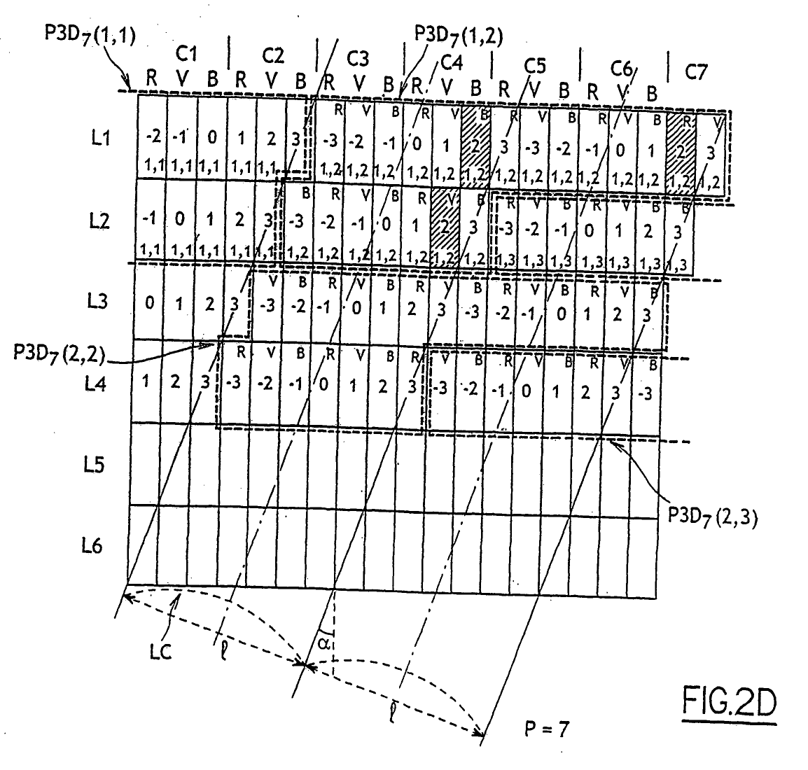

An exemplary autostereoscopic display device according to one embodiment of the invention will first be described with reference to FIGS. 2A to 2D.

The autostereoscopic display device 1 includes a plasma screen 2 connected to an electronic module 3 for generating encoded images, and a lenticular filter 4 in the form of an array of parallel cylindrical lenses inclined at an angle a in relation to the vertical axis of the plasma screen, this lenticular filter 4 being arranged in front of the plasma screen at a distance substantially equal to the focal length F1 of the lenses, which in an actual exemplary embodiment is 9 mm, while each color cell of the display screen has a width of 286 μm.

The autostereoscopic display device 1 according to—this embodiment is anticipated to provide a display of advertising or informational messages at a sufficiently large distance D from the screen, e.g., at a distance greater than 2 m, whereby each eye OG OD of a viewer receives separate optical images Im, In, provided by the lenticular array 4 and whereby, via a stereoscopic effect, this viewer perceives a three-dimensional image.

The focal distance f of the cylindrical lenses depends on the desired optimal distance. At this optimal distance, it is necessary for two successive images, encoded by two successive color cells, to be separated by the average distance Dy between two eyes, e.g., by 65 mm. The focal distance f of the lenses can be determined on the basis of the width CCh of a color cell and the optimal distance Dopt, using the formula:

f=CCh·Dopt/Dy≈9 mm

If, for example, the desired optimal distance Dopt is 2 m, and the width CCh is equal to 286 μm, then the focal distance f is approximately 9 mm.

The width l of the lenticule depends in particular on the desired optimal distance. When the viewer is at the optimal distance (final distance), the distance separating two points of the two-dimensional screen viewed simultaneously by one eye of the viewer, through two successive cylindrical lenses, is not exactly equal to the horizontal distance separating the axes of the cylindrical lenses. The relationship of proportionality is equal to Dopt/(Dopt+f).

The width l of each lenticular element can thus be determined from the following formula:

l=cos α·P·CCh·Dopt/(Dopt+f)

If, for example, the desired optimal distance Dopt is 2 m, then the width and the height of a color cell CCh are equal to 286 μm and 808 μm, respectively, the focal distance is equal to 9 mm, the number P of viewpoints is equal to 4, and the width l of the lenticule is then approximately 1.074 mm.

With reference to FIGS. 2A, 2B and 2C, the plasma screen—includes a matrix of elementary cells, comprising rows of pixels L1-L6 in FIG. 2, and columns of pixels C1-C6 in FIG. 2, each column of pixels including three columns of color cells R V B. For non-limiting illustrative purposes, each cell has a height CCv and a width CCh. The columns of the display matrix are successive Red, Green and Blue color cells.

To illustrate, for a plasma technology screen commercially available at present, such as the PIONEER PDP50MXE1, corresponding to a 768×1280 pixel matrix, each cell has a height CCv equal to 808 μm and a width CCh of 286 μm.

In a first exemplary embodiment shown in FIG. 2A and corresponding to a configuration having two viewpoints, a three-dimensional pixel P3D₂(1, 1)—includes four successive color cells V, B, R, V in a first lower row, in which the viewpoints 0_{1,1,} 1_{1,1,} 0_{11,} 1_{1,1,} are respectively encoded, and of two color cells B, R in a second upper row, in which the viewpoints 0_{1,1,} and 1_{1,1,} are respectively encoded. The three-dimensional pixel P3D₂(1, 2) has an inverted head-to-foot structure compared to that of the pixel P3D₂(1, 1). Each three-dimensional pixel is covered by two cylindrical lenses LC whose lenticular pitch l is defined so that l/cosα is equal to 2 times the product of the width of a color cell by the ratio Dopt/(Dopt+f). The loss of resolution is by a factor of 2 in the vertical direction and by a factor of 1 in the horizontal direction.

In a second exemplary embodiment shown in FIG. 2B and corresponding to a configuration having 4 viewpoints, each three-dimensional pixel occupies 12 color cells in two rows: 8 cells in one row and 4 cells in an adjacent row. Thus, the three-dimensional pixel P3D₄(1, 2) comprises four cells in the row L1, each encoded according to a viewpoint (−1, 0, 1, 2) and eight cells in the row L2, twice representing a succession of cells encoded according to four viewpoints. Each three-dimensional pixel is covered by two cylindrical lenses LC whose lenticular pitch l is defined so that l/cosα is equal to 4 times the product of the width of a color cell by the ratio Dopt/(Dopt+f).

Each viewpoint of a three-dimensional pixel is encoded in three non-adjacent cells. Thus, the image pixel 2_{1,2} is encoded in a cell R in screen row L2 and screen column C2, a cell V in screen row L1 and screen column C2, and a cell B in screen row L1 and in screen column C3.

The horizontally adjacent three-dimensional pixels are overlapping and have an inverted geometric structure. The loss of resolution resulting from this configuration having 4 viewpoints is of a factor of 2 in the vertical direction and in the horizontal direction.

In a third exemplary embodiment shown in FIG. 2C and corresponding to a configuration having 5 viewpoints, each three-dimensional pixel occupies 15 cells in two rows: 10 cells in a first row, corresponding to two times a series of 5 cells each encoding 5 viewpoints (−2, −1, 0, 1, 2), and 5 cells in an adjacent row, corresponding to a series of 5 cells encoding the 5 viewpoints. Thus, for non-limiting illustrative purposes, the three-dimensional pixel P3D₅(1, 2) includes, in the row L1, ten cells successively encoding the viewpoints (−2, −1, 0, 1, 2, −2, −1, 0, 1, 2) in the colors (B, R, V, B, R, V, B, R, V, B) and, in the row L2, five cells successively encoding the viewpoints (−2, −1, 0, 1, 2) in the colors (R, V, B, R, V).

Each three-dimensional pixel is covered by two cylindrical lenses LC whose lenticular pitch l is defined so that l/cosα is equal to 5 times the product of the width of a color cell by the ratio Dopt/(Dopt+f).

In this configuration having 5 viewpoints, two three-dimensional pixels use ten screen pixels. The loss of resolution is by a factor of 2.5 in the horizontal direction and by a factor of 2 in the vertical direction.

In a fourth exemplary embodiment shown in FIG. 2D and corresponding to a configuration having 7 viewpoints, each three-dimensional pixel occupies 21 cells in two rows: 14 cells in a first row, corresponding to two times a series of 7 cells each encoding 7 viewpoints (−3, −2, −1, 0, 1, 2, 3), and 7 cells in an adjacent row, corresponding to a series of 7 cells encoding the 7 viewpoints.

For each image pixel, a given viewpoint is encoded within a three-dimensional pixel, in three color cells split up into two cells in a row and one cell in an adjacent row. For example, the image pixel 2_{1,2} is encoded in a cell V in screen row L2 and screen column C4, a cell B in screen row L1 and screen column C4, and a cell R in screen row L1 and screen column C7.

As in the preceding configurations having 2, 4 and 5 viewpoints, the adjacent three-dimensional pixels are all horizontally overlapping. In this configuration having 7 viewpoints, 2 three-dimensional pixels use 14 screen pixels. The loss of resolution is by a factor of 3.5 in the horizontal direction and by a factor of 2 in the vertical direction.

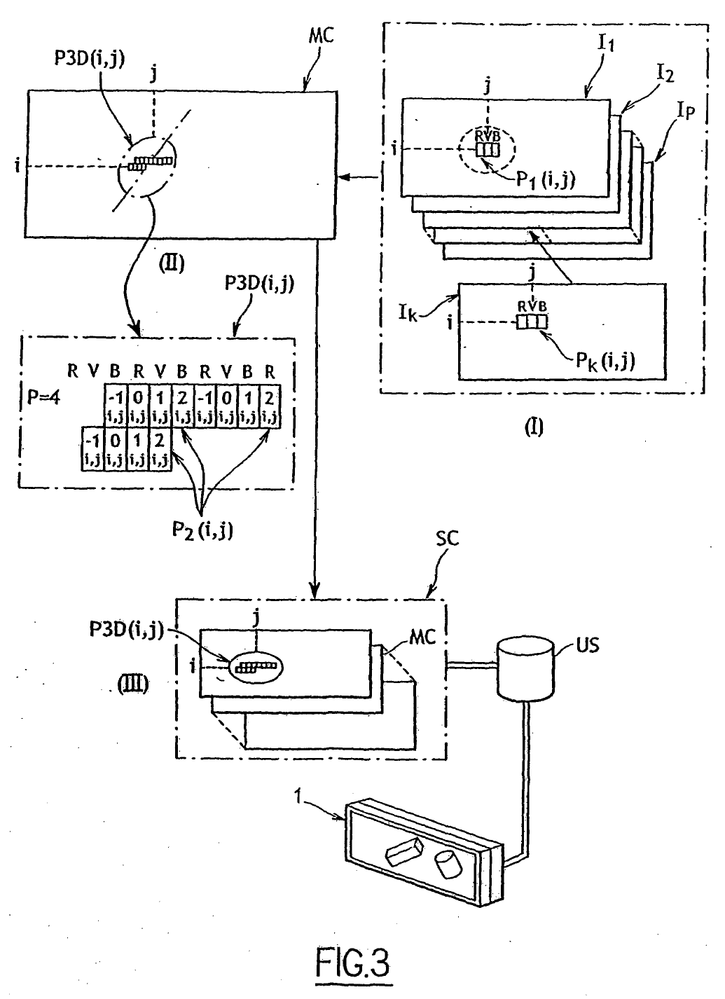

An example of implementing an autostereoscopic image synthesizing method according to the invention will now be described with reference to FIG. 3, these images being intended to supply an autostereoscopic display device according to the invention.

Considered first of all is a preliminary phase (I) for obtaining digital images according to a plurality P of viewpoints, e.g., numbering 4, that are appropriately chosen in order to obtain a stereoscopic effect. These P digital images can be either synthesized or collected from remote sites or image banks, or else acquired by film shooting.

For each viewpoint, each of these digital images I₁, I₂, . . . , I_{K}, . . . , I_{P}—includes a matrix of image pixels, each of these image pixels P_{I}(i, j), . . . , P_{K}(i, j) containing three pieces of color information R V B.

A second phase (II) of the synthesizing method—includes constructing a display matrix MC by creating, for each image point (i, j) of the viewpoints, a 3 D pixel, referenced as P3D(i, j) in FIG. 3, from the aggregation of the 4 viewpoints of the image pixel, using the encoding mode specific to the invention, i.e., a combined horizontal and vertical encoding of each encoding pixel P₁(I, j), . . . P_{K}(i, j), in order to produce a three-dimensional pixel P3D(i, j). To illustrate, in this three-dimensional pixel, the image pixel P₂(i, j) contributes to a cell V in an upper row and to two cells B and R in an upper row.

In a third phase (III), the display matrices MC each corresponding to an image of an encoded sequence SC, are then stored in a image storage unit US intended to be activated in response to a request coming from a control processor of an autostereoscopic display device 1 according to one aspect of the invention.

The invention is not limited to the examples just described and numerous features can be added to these examples without exceeding the scope of the invention. In particular, the invention is not limited to the single case of a plasma screen, but can be implemented with other screen types having a matrix structure, with contiguous or spaced-apart cells.

For the same screen, it is also possible to consider combining the specific encoding mode used in the display method according to the various embodiments with other pixel-encoding modes, which are known in the prior art, or which might be developed in the future, each encoding mode being applied to a specific or variable block of rows of the screen.

The synthesis method according to one aspect of the invention is therefore implemented only on a portion of the rows of a display screen, the remaining rows being subjected to a separate encoding mode from the one implemented in this method.

It is also possible to consider for the rows on which the synthesis method according to aspects of the invention is implemented to be determined dynamically on the basis of the scene being displayed.

1-14. (canceled)

15. An autostereoscopic display device including a matrix display screen and a lenticular array arranged in front of said display screen and having a lenticular axis that is inclined in relation to a vertical axis of said display screen, said lenticular array adapted to receive and optically process a raster image transmitted by said display screen, said raster image being encoded in order to integrate a plurality P of viewpoints of the same scene, said display screen including a matrix of screen pixels each including three color cells, said color cells being organized in rows and columns laid out so as to form columns of the same color within said screen, characterized the image transmitted by the display screen consists of a set of three-dimensional pixels each integrating the plurality P of viewpoints of an image pixel of said scene, each three-dimensional pixel occupying 3×P color cells in two adjacent rows within said screen.

16. The device of claim 15, wherein each three-dimensional pixel occupies 2×P adjacent color cells in one of said two adjacent rows and, in the other row, P adjacent color cells.

17. The device of claim 16, wherein the three-dimensional pixels are laid out so that two horizontally adjacent three-dimensional pixels are overlapping.

18. The device as claimed in claim 15, wherein the lenticular array consists of parallel cylindrical lenses with a lenticular pitch and an angle such that each three-dimensional pixel is substantially covered by two adjacent elementary lenticules.

19. The device of claim 18, wherein the lenticular pitch I and the tilt angle Q of the lenticular array are chosen such that:
I=cos α·P·CCh·Dopt/(Dopt+f)
where CCh is the width of a color cell, Dopt is the desired optimal display distance, and f is the focal distance of the lenticular array.

20. The device of claim 19, wherein the tilt angle a is chosen such that tan a is substantially equal to the ratio of the width (CCh) of a color cell to the height (CCV) of said color cell.

21. The device as claimed in claim 15, wherein, within each three-dimensional pixel, each viewpoint is encoded:
in a first cell of a first color, situated in a first row,
in a second cell of a second color, situated in said first row and offset by a number P of cells in relation to said first cell, and
in a third cell of a third color, situated in a second row adjacent to said first row, said third cell being horizontally offset by one cell in relation to said first cell.

22. The device as claimed in claim 15, wherein the number P of viewpoints is chosen from among 2, 4, 5 or 7.

23. The device as claimed in claim 15, wherein the electronic display screen is a plasma screen.

24. The device as claimed in claim 15, wherein the electronic display screen is a liquid crystal screen.

25. An autostereoscopic display method, implemented in an autostereoscopic display device as claimed in claim 15, including:
displaying a raster image previously encoded from an image acquired or collected from a plurality P of viewpoints, via a two-dimensional display screen, and
receiving and optically processing said displayed image, via a lenticular array arranged in front of said display screen and having a lenticular axis that is inclined in relation to a vertical axis of said display screen, so as to remotely generate a three-dimensional image, said raster image being encoded in order to integrate a plurality P of viewpoints of said image, wherein the optical processing carried out by the lenticular array is designed to process an encoded image consisting of a set of three-dimensional pixels each integrating the plurality P of viewpoints of an image pixel of said scene, each three-dimensional pixel occupying 3×P color cells in two adjacent rows within said screen.

26. A method for synthesizing a color autostereoscopic image, implemented in order to supply a display device as claimed in claim 15, including, from a plurality P of previously acquired or collected digital images (I) each in the form of a matrix of image pixels representing a scene, synthesis (II) of an encoded display matrix (Me) consisting of an assemblage of three-dimensional pixels each integrating the plurality P of viewpoints of an image pixel of said scene, each three-dimensional pixel occupying 3×P color cells in two adjacent rows within said screen.

27. The synthesis method of claim 26, wherein it is implemented only on a portion of the rows of a display screen, the remaining rows being subjected to a separate encoding mode from the one implemented in this method.

28. The synthesis method of claim 27, wherein the rows on which this method is implemented are determined dynamically on the basis of the scene being displayed.
